(19) United States
(12) Patent Application Publication
(10) Pub. No.: US 2008/0093296 A1
(43) Pub. Date: Apr. 24, 2008

(54) Separation of Solid Particles from the Liquid in Which They are Dispersed

(75) Inventor: William Graham, Gordon's Bay (ZA)

Correspondence Address: STITES & HARBISON PLLC, 1199 NORTH FAIRFAX STREET, SUITE 900, ALEXANDRIA, VA, 22314, US

(73) Assignee: DRESSEL PTE LTD., 068894, Singapore (SG)

(21) Appl. No.: 11/722,419

(22) PCT Filed: Dec. 15, 2005
(86) PCT No.: PCT/ZA05/00183

§ 371 Date: Jun. 21, 2007

(30) Foreign Application Priority Data
Dec. 22, 2004 (ZA) 2004/10306

(51) Int. Cl. B01D 63/10; B01D 65/02

(52) U.S. Cl. 210/636; 210/321.69; 210/484; 210/637

(57) ABSTRACT

An upright filter unit (10) is disclosed which comprises a membrane (16) consisting of a perforated, vertical permeate pipe (12) and a plurality of leaves (14) of semipermeable material which permits water to pass through it. The semi-permeable material defines a plurality of solids retention passages and a plurality of permeate passages. The leaves (14) are wound around the perforated vertical pipe (12) into which the permeate water flows, the membrane being inside a casing (40). An inlet (24) at the bottom of the unit allows raw water under pressure to flow to the solids retention passages of the membrane. An air inlet (32) at the upper end of the unit permits air under pressure to enter the upper end of the unit, and hence the upper ends of the solids retention passages, until the air and water pressures are balanced. Flushing of retained solids is achieved by closing the outlet from the perforated pipe and opening both a flushing water inlet and a flushing water outlet whilst maintaining air pressure at the upper end of the casing.

### FIELD OF THE INVENTION

This invention relates to the separation of solid particles from a liquid in which they are dispersed.

### BACKGROUND TO THE INVENTION

To remove fine, solid particles a few microns in size from water (or any other liquid) it is conventional to use semi-permeable materials. The materials used are porous to water molecules but the pores are sufficiently small to prevent solid particles passing through. The materials perform micro or ultra filtration depending on their pore size.

Conventionally a filter based on such material comprises an elongate core pipe which has rows of holes along it. Elongate leaves of semi-permeable material having one open side, but otherwise being in the form of sealed pockets, are fixed to the pipe with their open edges in communication with the rows of holes. There are mesh-like spacers between the pockets and in the pockets. The sealed pockets are wound tightly about the pipe, and the wound unit is slid into an elongate outer housing.

When water with entrained solid particles flows into the casing, it enters solids retention passages bounded between the leaves, the spacers between the pockets being in the solids retention passages. The water, but not the solids, permeates through the semi-permeable material into the pockets and thence to the pipe via the open edges of the pockets and the rows of holes.

After a period of use, the filter becomes blocked, or at least the flow rate decreases to such an extent that it is necessary to clean the filter. This is achieved by opening a valve which controls a waste exit from the casing, and feeding flushing water under pressure into the casing to sweep the water in the casing, and the solid particles, out of the casing through the waste exit.

The object of the present invention is to provide an improved method of operating a filter unit, an improved filter installation, and an improved method of making a filter unit.

### BRIEF DESCRIPTION TO THE INVENTION

According to one aspect of the present invention there is provided a method of operating an upright filter unit which includes a membrane comprising a permeate pipe and water permeable leaves through which water passes to reach said permeate pipe, the method comprising feeding raw feed water to the lower end of the unit, extracting permeate water from the lower end of the unit, and maintaining an above atmospheric pressure in the upper end of the unit by means of a permanent connection to a supply of gas under pressure.

The gas, for the sake of economy, will normally be air but other gases could be used.

To clean the membrane the method of operation comprises terminating the flow of raw water, opening a waste flow line communicating with the lower end of the unit and instituting flow of flushing water to the upper end of said unit whilst maintaining the supply of gas to the upper end of the unit so that water, gas and solid particles flow from said unit through said waste flow line.

The pressure can, during flushing of the filter unit, be maintained at a constant valve or can pulsate.

The present invention also provides an installation comprising an upright of filter unit which includes a membrane comprising a vertical permeate pipe and water permeable leaves through which water, passes to reach said permeate pipe, an inlet at the lower end of the unit for raw water, an outlet at the lower end of the unit for permeate, valve means for closing-off the supply of raw water, an inlet at the upper end of the unit, a supply of gas under pressure which is permanently connected to the inlet at the upper end of the unit whilst the unit is operating to separate liquid from entrained solids, a flushing water flow pipe leading to the inlet at the upper end of the unit, valve means for normally closing said flushing water flow pipe and which valve means can be opened to connect said flushing water flow pipe to a source of flushing water under pressure when cleaning is to be undertaken, and a waste outlet at the lower end of the unit for through which flushing water and solid particles leave the unit.

According to another aspect of the present invention there is provided a filter unit for separating solids from liquids consisting of a membrane comprising a permeate pipe and water permeable leaves through which water passes to reach said permeate pipe, the membrane having an end cap at each end thereof, and a casing formed in situ by winding resin coated fibres around the membrane and caps.

According to a further aspect of the present invention there is provided a method of manufacturing a filter unit which comprises rotating an assembly consisting of a membrane comprising a permeate pipe and water permeable leaves through which water passes to reach said permeate pipe, the membrane having an end cap at each end thereof, and winding resin coated fibres around the assembly thereby to fabricate a casing which is integrated with the membrane and the end caps.

The fibres are preferably in the form of glass fibres but other fibres such as carbon fibres and Kevlar fibres can be used.

### BRIEF DESCRIPTION OF THE DRAWINGS

For a better understanding of the present invention, and to show how the same may be carried into effect, reference will now be made, by way of example, to the accompanying drawings in which;

FIG. 1 is a section through a filter unit in accordance with the present invention;

FIG. 2 is an “exploded” view of the filter unit of FIG. 1;

FIGS. 3 and 4 are pictorial views of opposite sides of a filter installation;

FIGS. 5 and 6 are side elevations of opposite sides of the filter installation;

FIG. 7 is a top plan view of the filter installation;

FIGS. 8 and 9 are opposite end views of the filter installation; and

FIG. 10 is a circuit diagram of the filter installation.

### DETAILED DESCRIPTION OF THE DRAWINGS

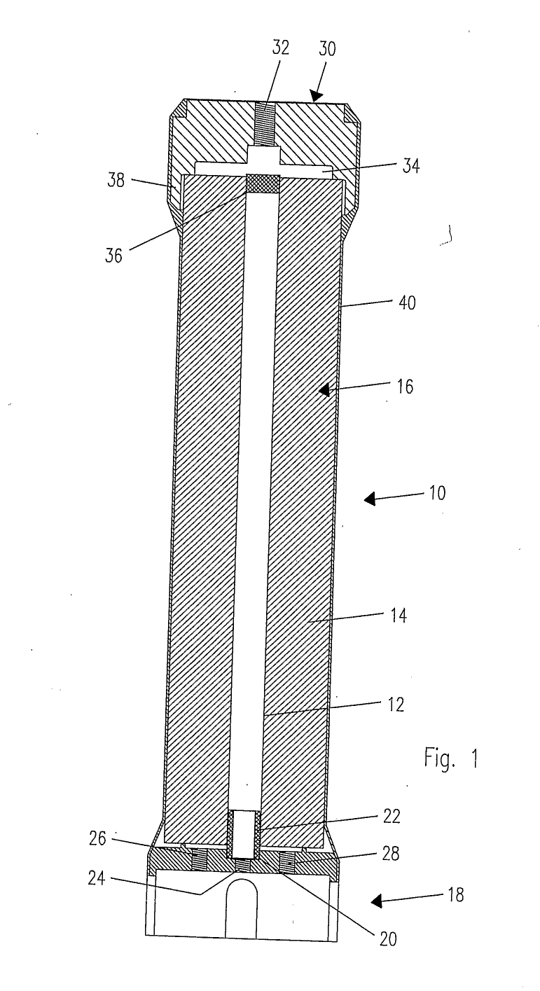

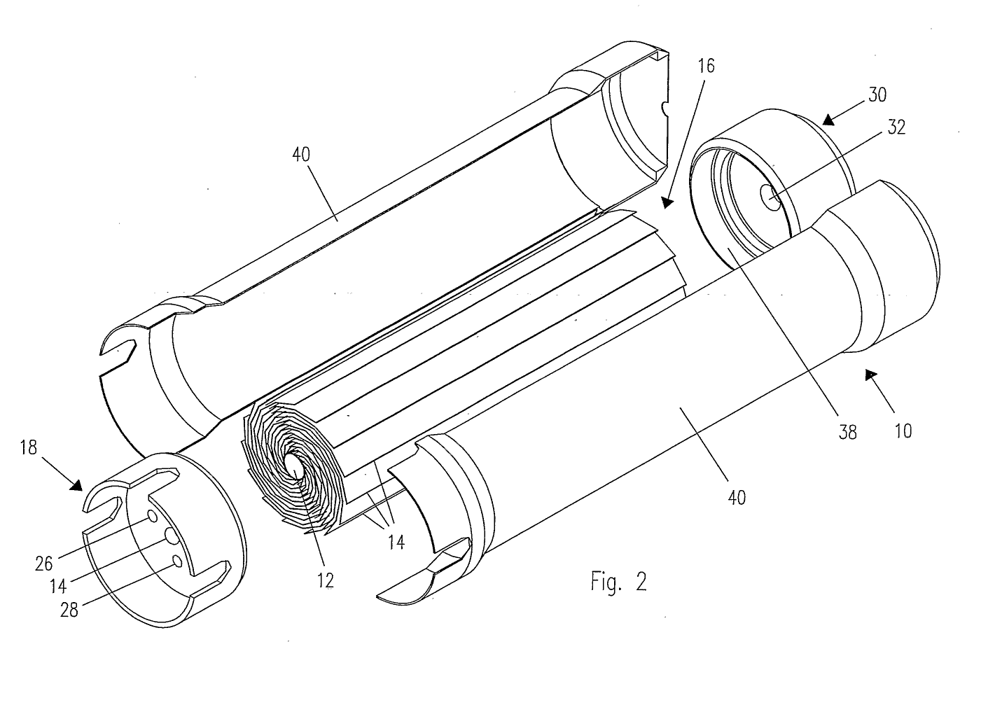

The filter unit 10 illustrated in FIGS. 1 and 2 comprises an elongate, vertical, perforated core pipe 12 around which elongate leaves 14 (FIG. 2) are wound. Each leaf 14 is in the form of a sealed pocket and is fabricated using semi-permeable material which permits water but not solid particles to pass through it. The inner edge of each pocket is open and it is this edge that is attached to the pipe 12. The pockets communicate with the interior of the pipe 12 via the multitude of perforations in the pipe 12. The construction of the pipe 12 and leaves 14 is conventional. In accordance with conventional nomenclature in the art, the structure comprising the pipe (designated 12) and water permeable leaves (designated 14) will be referred to as a “membrane”. The membrane is designated 16.

The filter unit, as illustrated in FIG. 1, further includes an end cap 18 at the lower end thereof. The end cap 18 has a central socket 20 which receives a tube 22. The tube 22 penetrates into the pipe 12 and connects the end cap 18 to the pipe 12. An outlet bore 24 in the end cap 18 communicates with the interior of the tube 22 and hence with the interior of the pipe 12 and enables permeate which has entered the pipe 12 to flow from the filter unit 10. The tube 22 temporarily connects the end cap 18 to the membrane 16.

The end cap 18 additionally has two more bores 26, 28. The bore 26 is the raw water feed inlet and the bore 28 is the flushing outlet. It is through the bore 28 that solid particles are swept from the casing during the cleaning procedure as will be described hereinafter. There can if desired be more than one bore 26 and more than one bore 28.

At the upper end of the filter unit 10 there is a further end cap 30. The end cap 30 has an axial bore 32 through it to which a supply of air under pressure (not shown in FIGS. 1 and 2) is attached. There is a space 34 between the end cap 30 and the membrane 16. The upper end of the core pipe 12 is closed by a plug 36.

To fabricate the filter unit 10, the membrane 16 has the two end caps 18, 30 fitted to it and the composite structure is mounted on a rotatable mandrel (not shown). The mandrel comprises two co-axial, axially spaced shafts which enter the bores 24 and 32 thereby rotatably to mount the end caps 18, 20 and the membrane 16.

The end cap 30 includes a sleeve 38 in which the end of the membrane 16 is fitted thereby providing the requisite temporary connection between the cap 30 and the membrane 16. The mandrel is rotated and a casing 40 is fabricated by winding resin coated glass or other fibre strands about the membrane 16 and end caps 18, 30. The casing 40 joins the membrane 16 to the end caps 18, thereby to form an integrated unit which does not have any space between the outer surface of the membrane 16 and the inner surface of the casing 40.

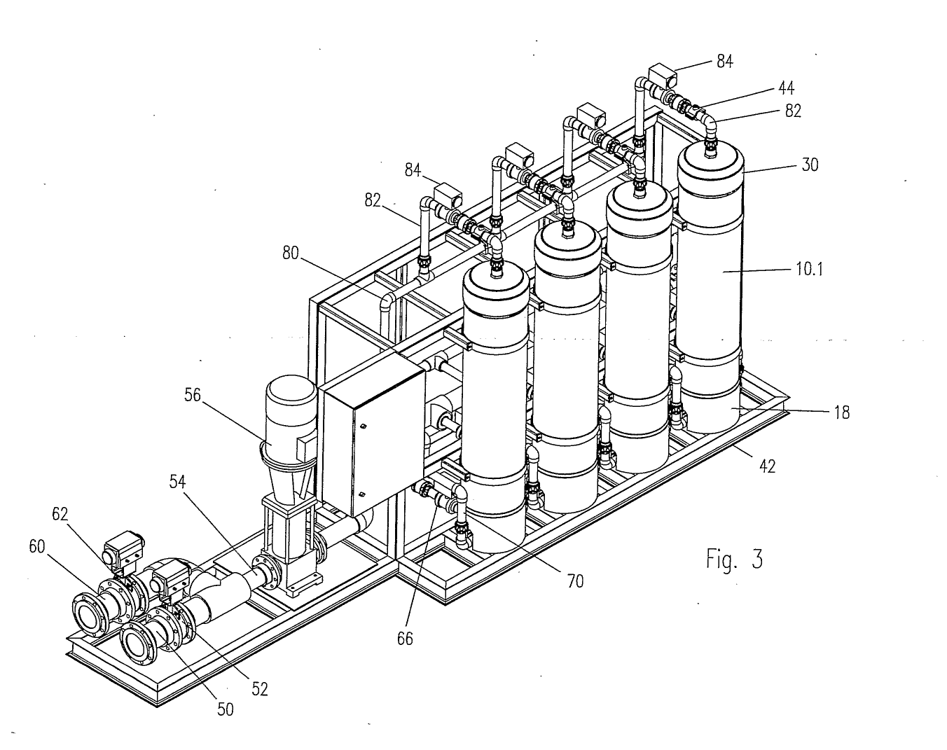

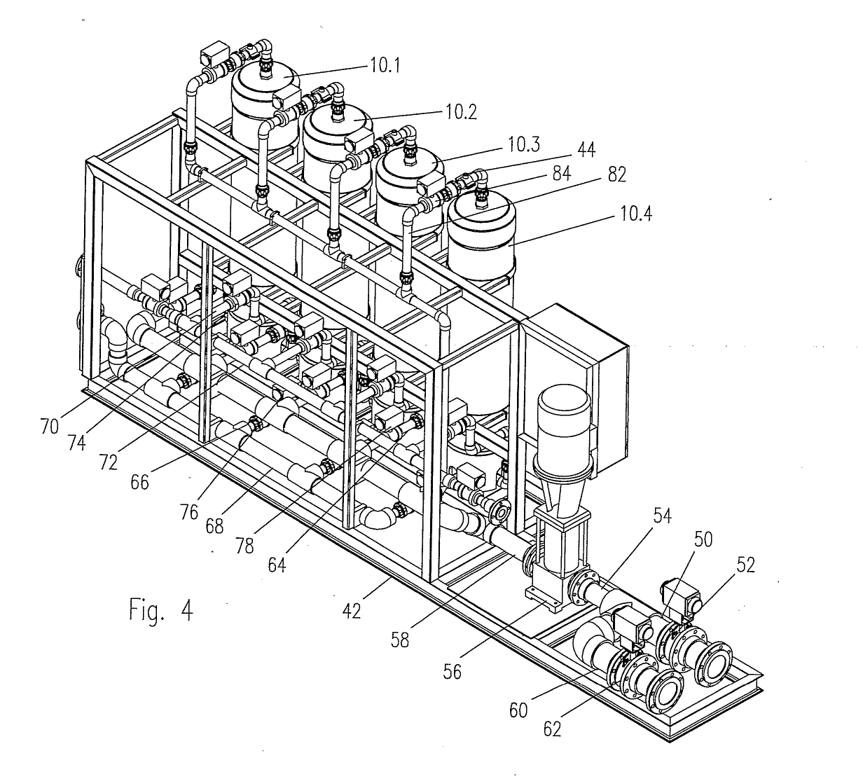

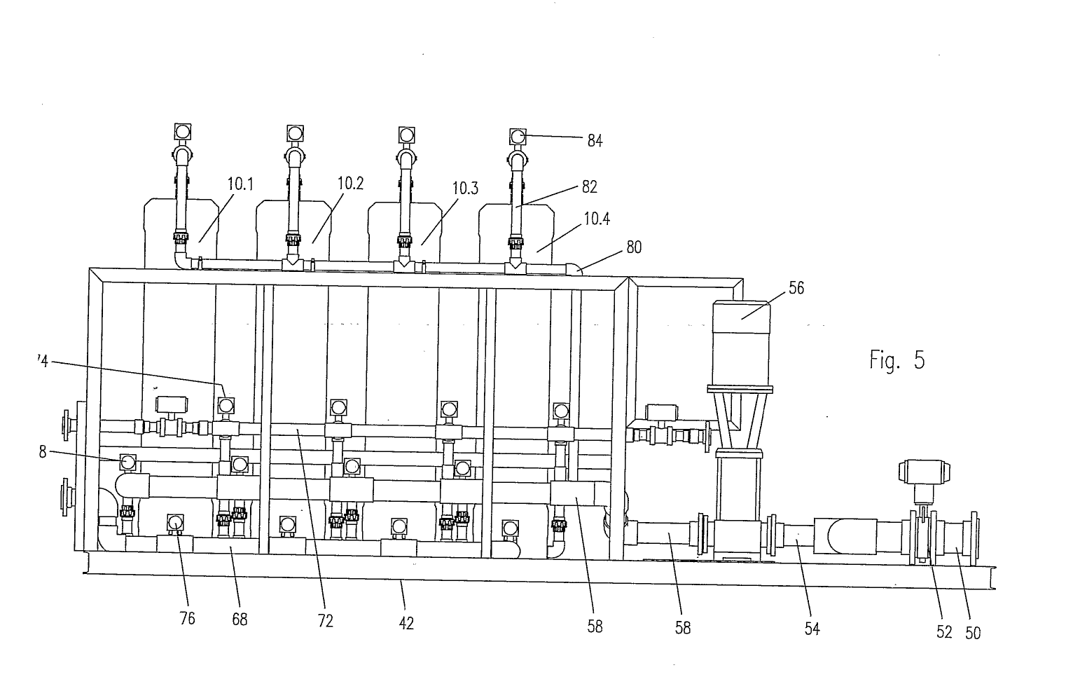

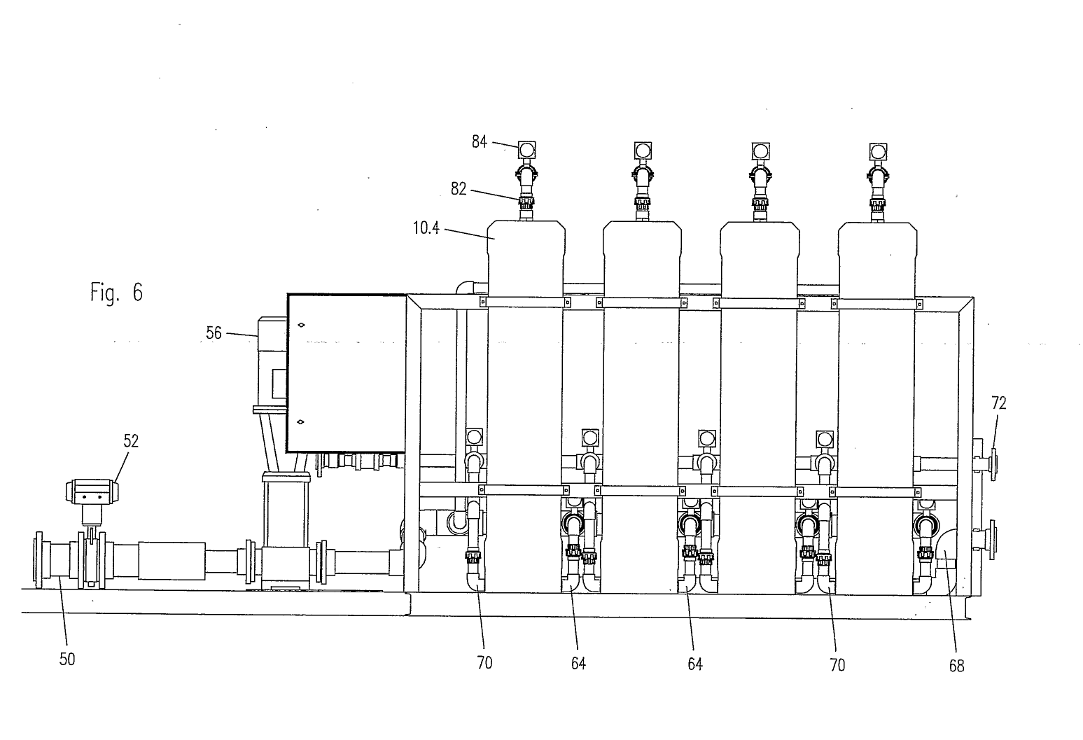

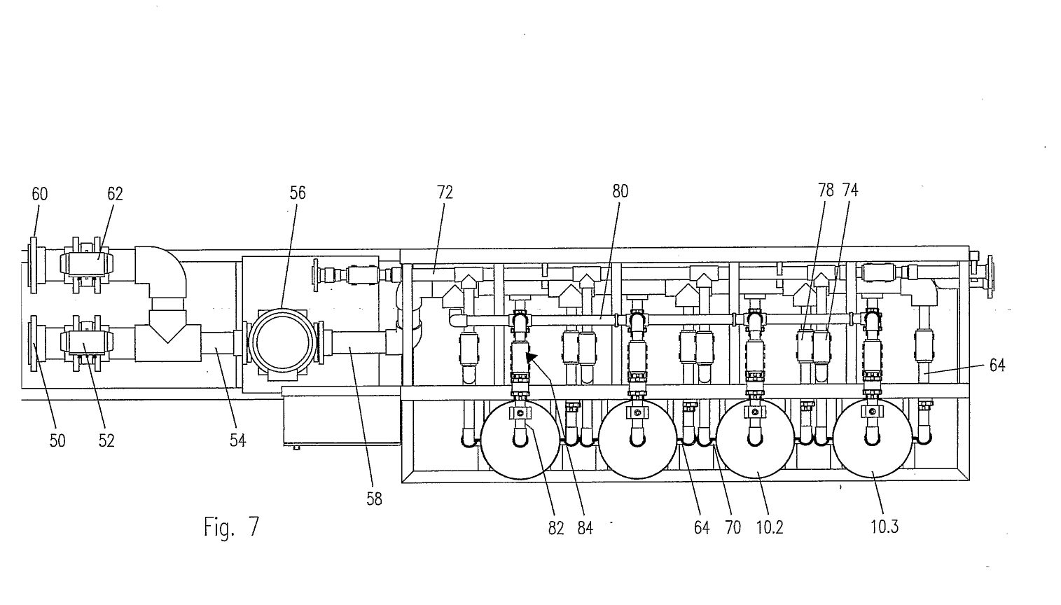

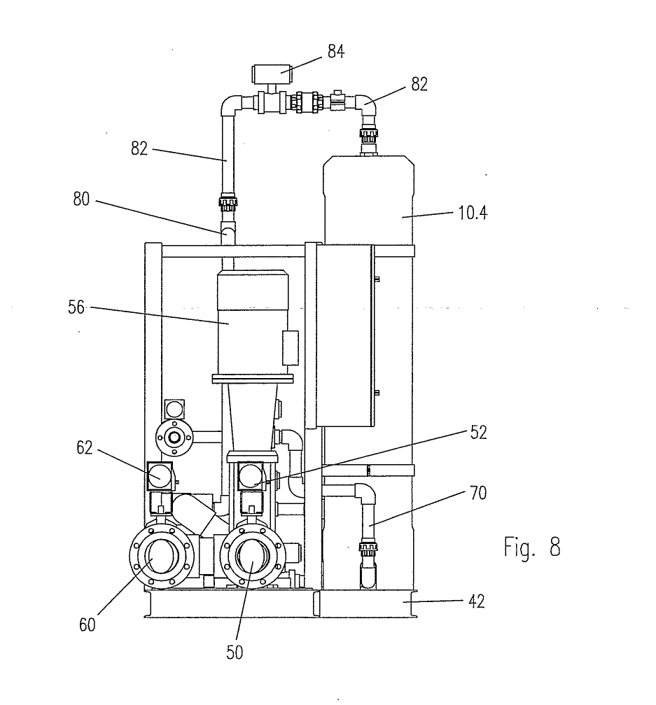

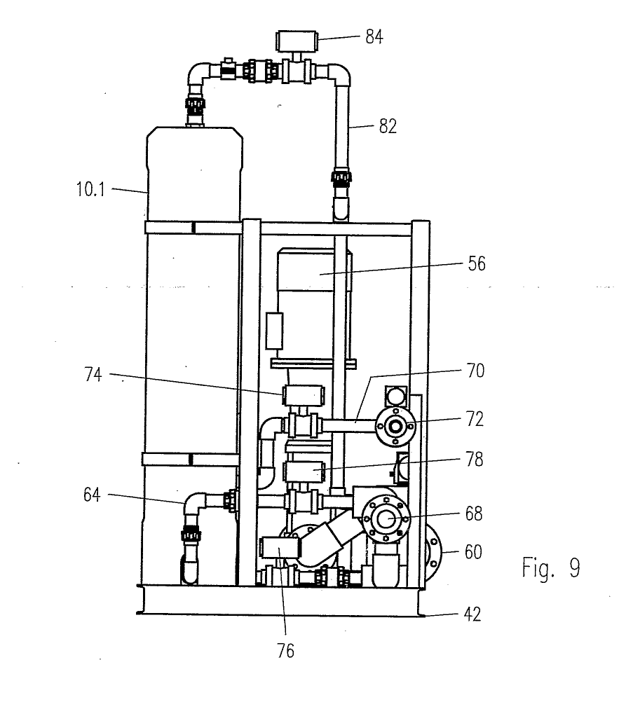

Turning now to FIGS. 3 to 10, the filter installation illustrated comprises a base frame 42 on which all the remaining components of the installation are mounted.

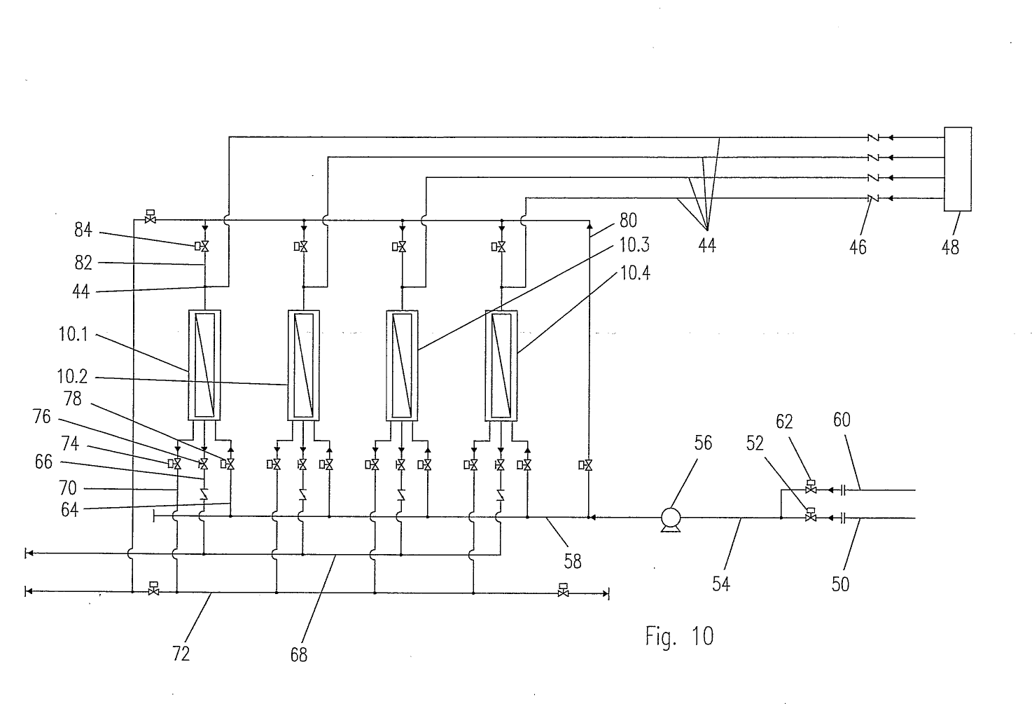

Four filter units 10.1, 10.2, 10.3 and 10.4 of the form described above are mounted on the frame 42. Pipes 44 are connected to the inlet bores 32 of the four filter units. Each pipe 44 leads to a valve 46 (FIG. 10) which controls flow from an air supply 48.

The water to be treated enters via an inlet 50 and flows through a valve 52 to a pipe 54 which connects to the suction side of a pump 56. The pressure side of the pump is connected to a manifold 58. There is a second inlet 60 for flushing water and a valve 62 is provided between the inlet 60 and the pipe 54.

The manifold 58 is connected by four branch pipes 64 to the bores 26 of units 10.1, 10.2 etc. Thus the raw water flows into the solids retention passages of the membranes 16. Each bore 24 is connected to an outlet pipe 66 and the pipes 66 lead to a permeate outlet manifold 68. The other bore 28 of each end cap 18 is connected to a pipe 70, and the pipes 70 lead to a manifold 72. There are valves 74 in the pipes 70, valves 76 in the pipes 66 and valves 78 in the pipes 64.

A pipe 80 connects the manifold 58 to branch pipes 82 which lead to the inlet bores 32 at the upper ends of the units 10.1, 10.2 etc. There are normally closed valves 84 in the branch pipes 82. The pipes 82 join the pipes 44 so that the bores 32, for flushing purposes, can be connected simultaneously to the air supply designated 48 and to the clean water supply 60.

In normal operation the raw water with solid particles in it is pumped by the pump 56 into the manifold 58, then into the pipes 64, through the bores 26 and into the membranes 16. The water which flows into the membranes 16 permeates through the leaves 14 and exits via the pipes 12, tubes 22 and bores 24. From the bores 24 the water flows to the pipes 66 and thence to the manifold 68 via the valves 76.

The upper ends of the units 10.1, 10.2 etc are permanently connected to the air supply 48 thereby to maintain a pressure at above atmospheric in each unit 10.1, 10.2 etc. The pressure of the raw feed water at the bores 26 is sufficient to balance the air pressure in such manner that the water fills the casings 40 substantially to the top whilst leaving an air space above the water.

When the filter units become clogged, the valve 52 is shut and the valve 62 is opened. Simultaneously the valves 74 and 84 are opened and the valves 76, 78 closed. The valves 74, 84, in normal operation, are closed and the valves 76, 78 are normally open. Flushing water flows from the pump 56 to the manifold 58 and then to the pipe 80. From the pipe 80 the flushing water flows through the pipes 82 to the bores 32 with the incoming air which was able to start flowing through the units immediately the valves 78 were closed to remove water pressure from the lower ends of the membranes.

The air and flushing water flows through the solids retention passages of the membranes, out through the bores 28 to the pipes 70 and then to the manifold 72 carrying the filtered-out particles with it.

Air under pressure is constantly supplied to the upper end of each filter unit. During flushing the air pressure can be maintained at a constant value or can be caused to pulsate.

1. A method of operating an upright filter unit which includes a membrane comprising a permeate pipe and water permeable leaves through which water passes to reach said permeate pipe, the method comprising feeding raw feed water to the lower end of the unit, extracting permeate water from the lower end of the unit, and maintaining an above atmospheric pressure in the upper end of the unit by means of a permanent connection to a supply of gas under pressure.

2. A method as claimed in claim 1, wherein, to clean the membrane, the method of operation comprises terminating the flow of raw feed water, opening a waste flow line communicating with the lower end of the unit and instituting flow of flushing water to the upper end of said unit whilst maintaining the gas supply to the upper end of the unit so that water, gas and solid particles flow from said unit through said waste flow line.

3. A method as claimed in claim 2, wherein the pressure of the gas supply pulsates during flushing.

4. An installation comprising a filter unit which includes a membrane comprising a vertical permeate pipe and water permeable leaves through which water passes to reach said permeate pipe, an inlet at the lower end of the unit for raw feed water, an outlet at the lower end of the unit for permeate, valve means for closing-off the supply of raw water, an inlet at the upper end of the unit, a supply of gas under pressure which is permanently connected to said inlet at the upper end of the unit whilst the unit is operating to separate liquid from entrained solids, a flushing water flow pipe leading to the inlet at the upper end of the unit, valve means for normally closing said flushing water flow pipe and which valve means can be opened to connect said flushing water flow pipe to a source of flushing water under pressure when cleaning is to be undertaken, and a waste outlet at the lower end of the unit through which flushing water and solid particles leave the unit.

5. A filter unit for separating solids from liquids which comprises a membrane comprising a permeate pipe and water permeable leaves through which water passes to reach said permeate pipe, the membrane having an end cap at each end thereof, and a casing formed in situ by winding resin coated fibres around the membrane and caps.

6. A method of manufacturing a filter unit which comprises rotating an assembly consisting of a membrane comprising a permeate pipe and water permeable leaves through which water passes to reach said permeate pipe, the membrane having an end cap at each end thereof, and winding resin coated fibres around the rotating assembly thereby to fabricate a casing which is integrated with the membrane and the end caps.

7. A method as claimed in claim 6, wherein said fibres are selected from the group comprising glass fibres, carbon fibres and Kevlar fibres.
